(19) United States
(12) Patent Application Publication
(10) Pub. No.: US 2008/0280641 A1
(43) Pub. Date: Nov. 13, 2008

(54) METHODS AND DEVICES FOR GENERATING MULTIMEDIA CONTENT IN RESPONSE TO SIMULTANEOUS INPUTS FROM RELATED PORTABLE DEVICES

(75) Inventors: Andreas Kristensson, Lund (SE); Erik Starck, Sundbyberg (SE)

Correspondence Address: MYERS BIGEL SIBLEY & SAJOVEC, P.A., P.O. BOX 37428, RALEIGH, NC, 27627, US

(73) Assignee: SONY ERICSSON MOBILE COMMUNICATIONS AB

(21) Appl. No.: 11/747,648

(22) Filed: May 11, 2007

(51) Int. Cl. H04B 7/00

(52) U.S. Cl. 455/556.1

(57) ABSTRACT

Methods of operating a mobile device having a transceiver configured to communicate with a wireless communication network include detecting a motion of the mobile device using a sensor associated with the mobile device, and generating a signal indicative of the motion of the mobile device. An ancillary sensor signal is received from a sensor of an ancillary device associated with the mobile device, and a multimedia object is generated and stored in response to the motion of the mobile device and the ancillary sensor signal. A mobile device includes a sensor that detects motion of the mobile device and generates a signal indicative of a motion of the mobile device, a transceiver configured to communicate with a wireless communication network, and a short-range wireless communication interface configured to receive an ancillary sensor signal from an ancillary device. The device further includes a controller that generates a multimedia object in response to the signal indicative of the motion of the mobile device and the ancillary sensor signal, and stores the multimedia object.

### FIELD OF THE INVENTION

The present invention relates to electronic devices and methods of operating the same, and, more particularly, to mobile device user input and methods thereof.

### BACKGROUND

Mobile electronic devices, such as mobile terminals, increasingly provide a variety of communications, multimedia, and/or data processing capabilities. For example, mobile terminals, such as cellphones, personal digital assistants, and/or laptop computers, may provide storage and/or access to data in a wide variety of multimedia formats, including text, pictures, music, and/or video.

Furthermore, many mobile terminals include sensors that may be used to create multimedia content. For example, many mobile terminals, such as cellphones, may be equipped with digital camera functionality that is capable of generating digital motion pictures as well as digital still images. When an image captured using the digital camera is displayed on the mobile terminal, it may be possible to select and/or manipulate the displayed image using the keypad. However, in order to facilitate the manipulation of content, such as digital images, mobile devices may include alternative input devices, such as sensor devices responsive to touch, light and/or motion.

In particular, mobile devices may include motion sensors, such as tilt sensors and/or accelerometers. As such, applications may be included in mobile devices that take advantage of these capabilities for operation and/or for manipulation of data. For example, it is known to provide menu navigation and selection on a mobile device via tilting and/or shaking the housing of the device. Similarly, it is known to provide video games on a mobile device that utilize predefined motions of the device housing for manipulation of one or more on-screen characters or the like. More specifically, by tilting the device housing, a user can move an on-screen character in one of eight directions. In both cases, the motion sensor may assess the movement of the device housing and execute a desired action associated with the movement.

### SUMMARY

Some embodiments of the invention provide methods of operating a mobile device having a transceiver configured to communicate with a wireless communication network. The methods include detecting a motion of the mobile device using a sensor associated with the mobile device, and generating a signal indicative of the motion of the mobile device. An ancillary sensor signal is received from a sensor of an ancillary device associated with the mobile device, and a multimedia object is generated in response to the motion of the mobile device and/or the ancillary sensor signal. The multimedia object is stored.

The methods may further include combining the signal indicative of the motion of the mobile device with the ancillary sensor signal to form a combined input signal, and generating the multimedia object may be performed in response to the combined input signal.

The methods may further include transmitting the signal indicative of the motion of the mobile device and the ancillary sensor signal to a remote terminal. Combining the signal indicative of the motion of the mobile device with the ancillary sensor signal to form a combined input signal may be performed at the remote terminal.

The ancillary sensor signal may include a signal indicative of a motion of the ancillary device. Generating the multimedia object may include generating the multimedia object in response to the motion of the mobile device, the ancillary sensor signal, and a signal indicative of a motion of the ancillary device.

The multimedia object may include a sound file, an image file, and/or a video file, and the methods may further include playing the multimedia object using the mobile device and/or the ancillary device

The methods may further include transmitting the multimedia object to a remote terminal, and storing the multimedia object at the remote terminal.

The methods may further include transmitting the ancillary sensor signal to the mobile device using a short-range wireless communication interface including an RF or infrared communication interface.

The methods may further include placing the mobile device into a multimedia content generation mode prior to detecting the motion of the mobile device. In the multimedia content generation mode, the mobile device may be configured to not respond to incoming call alerts from the wireless communication network, to send a “busy” status signal to the network in response to an incoming call notification, and/or to forward an incoming call received over the wireless communication network to a call forwarding number and/or a voicemail mailbox.

The methods may further include selecting an object type for the multimedia object, and selecting an input type for the mobile device and the ancillary device.

Methods of operating a mobile device according to further embodiments of the invention include retrieving an existing multimedia object, detecting a motion of the mobile device having a transceiver configured to communicate with a wireless communication network, using a sensor associated with the mobile device, and generating a signal indicative of the motion of the mobile device. The methods further include receiving an ancillary sensor signal in response to an input of an ancillary device associated with the mobile device, modifying the existing multimedia object in response to the motion of the mobile device and/or the ancillary sensor signal to generate a modified multimedia object, and storing the modified multimedia object.

The methods may further include combining the signal indicative of the motion of the mobile device with the ancillary sensor signal to form a combined input signal, and modifying the multimedia object may be performed in response to the combined input signal.

The ancillary sensor signal may include a signal indicative of a motion of the ancillary device.

A mobile device according to some embodiments includes a sensor configured to detect a motion of the mobile device and to generate a signal indicative of a motion of the mobile device, a transceiver configured to communicate with a wireless communication network, and a short-range wireless communication interface configured to receive an ancillary sensor signal from an ancillary device. The device further includes a controller configured to generate a multimedia object in response to the signal indicative of the motion of the mobile device and/or the ancillary sensor signal, and to store the multimedia object.

The controller may be further configured to combine the signal indicative of the motion of the mobile device with the ancillary sensor signal to form a combined input signal, and to generate the multimedia object in response to the combined input signal.

The controller may be configured to place the mobile device into a multimedia content generation mode in which the mobile device is configured to not respond to incoming call alerts from the wireless communication network, to send a “busy” status signal to the network in response to an incoming call notification, and/or to forward an incoming call received over the wireless communication network to a call forwarding number and/or a voicemail mailbox.

The controller may be configured to generate the multimedia object in response to the signal indicative of the motion of the mobile device, the ancillary sensor signal, and a signal indicative of a motion of the ancillary device.

The controller may be configured to retrieve an existing multimedia object and to modify the existing multimedia object in response to the signal indicative of the motion of the mobile device and the ancillary sensor signal.

The sensor may include a motion sensor including a pair of parallel sensors configured to sense linear motion along a first axis and rotational motion along a second axis that is orthogonal to the first axis, and the motion sensor is configured to generate the signal indicative of a motion of the mobile device.

Although described above primarily with respect to method and device aspects, it will be understood that the present invention may be embodied as methods, electronic devices, and/or computer program products.

### BRIEF DESCRIPTION OF THE DRAWINGS

FIG. 1 is a block diagram that illustrates a mobile terminal in accordance with some embodiments of the present invention.

FIG. 2 is a block diagram that illustrates an ancillary device in accordance with some embodiments of the present invention.

FIGS. 3A and 3B illustrate connection and/or movement of mobile terminals and/or ancillary dev devices in accordance with some embodiments of the present invention.

FIG. 4 is a flowchart illustrating exemplary methods for operating a mobile device and/or an ancillary device in accordance with some embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items, and may be abbreviated as “/”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain or store the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as any mobile electronic device that includes data storage functionality.

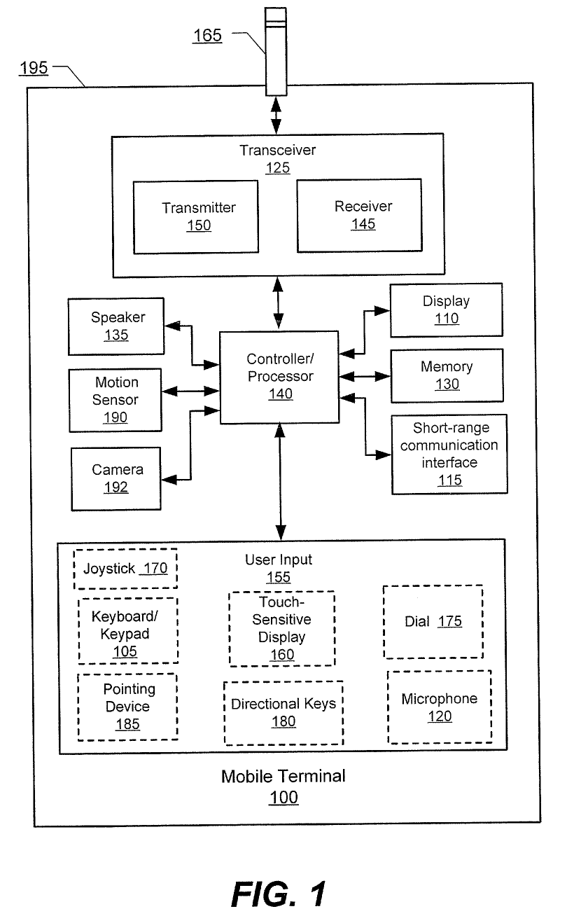

FIG. 1 is a block diagram illustrating a mobile terminal 100 in accordance with some embodiments of the present invention. Referring now to FIG. 1 the mobile terminal 100 includes a transceiver 125, a memory 130, a speaker 135, a controller/processor 140, a motion sensor 190, a camera 192, a display 110 (such as a liquid crystal display), a short-range communication interface 115, and a user input interface 155 contained in a housing 195. The transceiver 125 typically includes a transmitter circuit 150 and a receiver circuit 145, which cooperate to transmit and receive radio frequency signals to and from base station transceivers via an antenna 165. The radio frequency signals transmitted between the mobile terminal 100 and the base station transceivers may include both traffic and control signals (e.g., paging signals/messages for incoming calls), which are used to establish and maintain communication with another party or destination. The radio frequency signals may also include packet data information, such as, for example, general packet radio system (GPRS) information.

The short-range communication interface 115 may include an infrared (IR) transceiver configured to transmit/receive infrared signals to/from other electronic devices via an IR port and/or may include a Bluetooth (BT) transceiver. The short-range communication interface may also include a wired data communication interface, such as a USB interface and/or an IEEE 1394/Firewire communication interface.

The memory 130 may represent a hierarchy of memory that may include volatile and/or non-volatile memory, such as removable flash, magnetic, and/or optical rewritable non-volatile memory. The user input interface 155 may include a microphone 120, a joystick 170, a keyboard/keypad 105, a touch sensitive display 160, a dial 175, a directional key(s) 180, and/or a pointing device 185 (such as a mouse, trackball, touch pad, etc.). However, depending on the particular functionalities offered by the mobile terminal 100, additional and/or fewer elements of the user interface 155 may actually be provided. For instance, the touch sensitive display 160 may be provided in a PDA that does not include a display 110, a keypad 105, and/or a pointing device 185.

The controller/processor 140 is coupled to the transceiver 125, the memory 130, the speaker 135, the motion sensor 190 and the user interface 155. The controller/processor 140 may be, for example, a commercially available or custom microprocessor (or processors) that is configured to coordinate and manage operations of the transceiver 125, the memory 130, the speaker 135, the motion sensor 190 and/or the user interface 155. With respect to their role in various conventional operations of the mobile terminal 100, the foregoing components of the mobile terminal 100 may be included in many conventional mobile terminals and their functionality is generally known to those skilled in the art.

The controller 140 is configured to communicate with the memory 130 and the motion sensor 190 via an address/data bus. The memory 130 may be configured to store several categories of software and data, such as an operating system, application programs, input/output (I/O) device drivers and/or data. The operating system controls the management and/or operation of system resources and may coordinate execution of applications and/or other programs by the controller 140. The I/O device drivers typically include software routines accessed through the operating system by the application programs to communicate with input/output devices, such as those included in the user interface 155, and/or other components of the memory 130. The data may include a variety of data used by the application programs and/or the operating system. More particularly, according to some embodiments of the present invention, the data may include motion data, generated, for example, by the motion sensor 190.

Still referring to FIG. 1, the motion sensor 190 is configured to detect a predefined localized movement of the housing 195. In particular, the motion sensor 190 may include one or more of accelerometers configured to detect movement of the mobile terminal 100 along and/or about one or more axes.

For example, the motion sensor 190 may include one or more accelerometers and/or a tilt sensors configured to detect moving, twisting, tilting, shaking, waving and/or snapping of the mobile device housing 195. A movement of the mobile device housing 195 may correspond to a default predefined movement stored in the memory 130 of the mobile device 100, or may be a user-defined movement. The motion sensor 190 may be configured to detect the predefined localized movement.

For example, upon detection of a predefined localized movement of the mobile device housing 195, the motion sensor 190 may generate one or more parameters that correspond to the detected predefined localized movement. These parameters may be stored in the memory 130 as primary device motion data.

Although FIG. 1 illustrates an exemplary hardware/software architecture that may be used in mobile terminals and/or other electronic devices for controlling operation thereof, it will be understood that the present invention is not limited to such a configuration but is intended to encompass any configuration capable of carrying out operations described herein. For example, although the memory 130 is illustrated as separate from the controller 140, the memory 130 or portions thereof may be considered as a part of the controller 140. More generally, while particular functionalities are shown in particular blocks by way of illustration, functionalities of different blocks and/or portions thereof may be combined, divided, and/or eliminated. Moreover, the functionality of the hardware/software architecture of FIG. 1 may be implemented as a single processor system or a multi-processor system in accordance with various embodiments of the present invention.

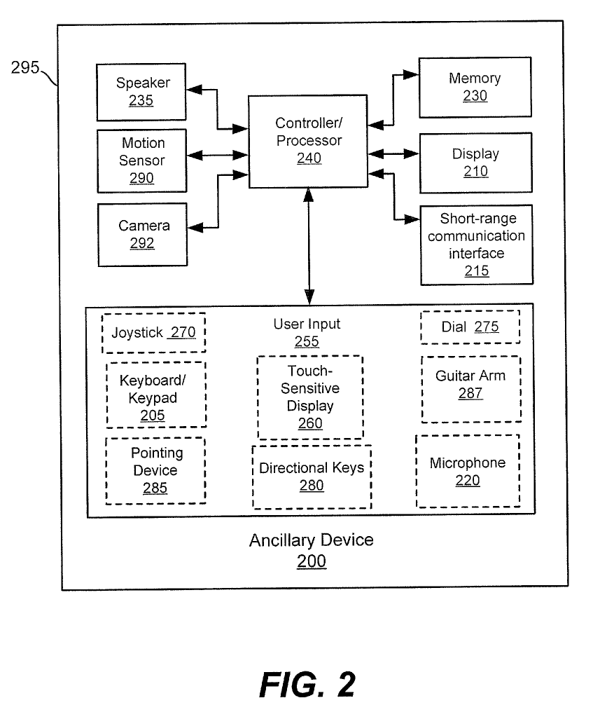

FIG. 2 is a block diagram illustrating a ancillary device 200 in accordance with some embodiments of the present invention. According to some embodiments, an ancillary device 200 may be used in conjunction with a mobile terminal 100 to generate coordinate motion/sensor data that can be combined to generate a multimedia object in a multimedia object generation mode.

Referring now to FIG. 2 the ancillary device 200 may include a memory 230, a speaker 235, a controller/processor 240, a motion sensor 290, a camera 292, a display 220 (such as a liquid crystal display), a short-range communication interface 215, and a user input interface 255 contained in a housing 295.

The short-range communication interface 215 may include an infrared (IR) transceiver configured to transmit/receive infrared signals to/from other electronic devices via an IR port and/or may include a Bluetooth (BT) transceiver. The short-range communication interface may also include a wired data communication interface, such as a USB interface and/or an IEEE 1394/Firewire communication interface or other wired communication interface. In particular, the short range communication interface 215 may enable the ancillary device 200 to communicate over short range with a mobile terminal 100.

The memory 230 may represent a hierarchy of memory that may include volatile and/or non-volatile memory, such as removable flash, magnetic, and/or optical rewritable non-volatile memory. The user input interface 255 may include an input device including a sensor, such as a microphone 220, a joystick 270, a keyboard/keypad 205, a touch sensitive display 260, a dial 275, a directional key(s) 280, a guitar arm 287, and/or a pointing device 285 (such as a mouse, trackball, touch pad, etc.). However, depending on the particular functionalities offered by the mobile terminal 200, additional and/or fewer elements of the user interface 255 may actually be provided. For instance, the touch sensitive display 260 may be provided in a PDA that does not include a display 220, a keypad 205, and/or a pointing device 285.

The controller/processor 240 is coupled to the transceiver 225, the memory 230, the speaker 235, the motion sensor 290 and the user interface 255. The controller/processor 240 may be, for example, a commercially available or custom microprocessor (or processors) that is configured to coordinate and manage operations of the transceiver 225, the memory 230, the speaker 235, the motion sensor 290 and/or the user interface 255.

The controller 240 is configured to communicate with the memory 230 and the motion sensor 290 via an address/data bus. The memory 230 may be configured to store software and/or data. For example, the memory 230 may be configured to store motion data indicative of a localized movement of the ancillary device 200, generated, for example, by the motion sensor 290.

Still referring to FIG. 2, the motion sensor 290 is configured to detect a predefined localized movement of the housing 295. In particular, the motion sensor 290 may include one or more of accelerometers configured to detect movement of the mobile terminal 200 along and/or about one or more axes.

For example, the motion sensor 290 may include an accelerometer and/or a tilt sensor configured to detect moving, twisting, tilting, shaking, waving and/or snapping of the mobile device housing 295. A movement of the mobile device housing 295 may correspond to a default predefined movement stored in the memory 230 of the mobile device 200, or may be a user-defined movement. The motion sensor 290 may be configured to detect the predefined localized movement.

For example, upon detection of a predefined localized movement of the mobile device housing 295, the motion sensor 290 may generate one or more parameters that correspond to the detected predefined localized movement. These parameters, which may comprise ancillary device motion data, may be stored in the memory 230 and/or may be transmitted to the mobile device 100 over the short-range communication interface 295.

Computer program code for carrying out operations of devices discussed above with respect to FIGS. 1 and 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

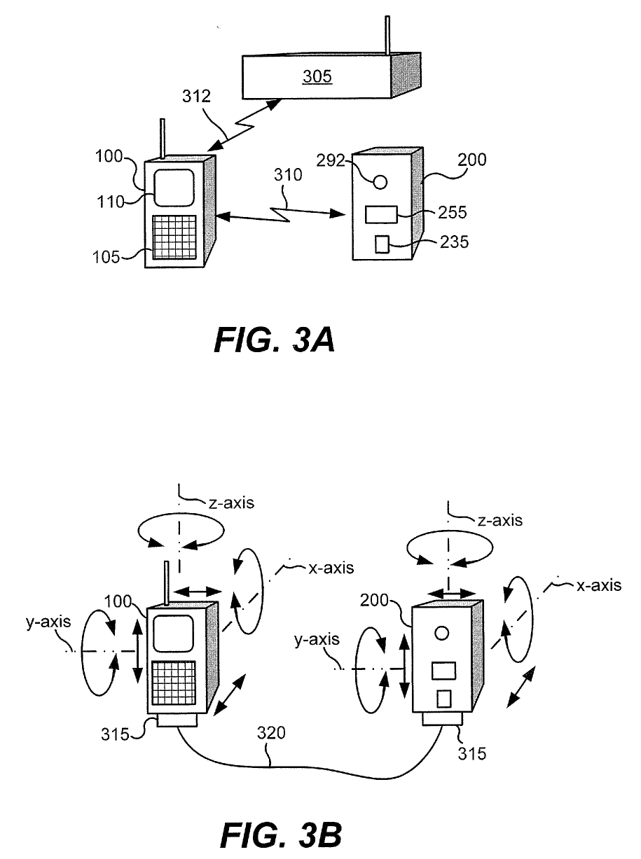

Referring now to FIG. 3A, a mobile terminal 100 and an ancillary device 200 can communicate with one another via a wireless short range communication link 310. In some embodiments, the wireless short-range communication link 310 may include a short-range RF communication link, such as a Bluetooth link, that may permit the mobile terminal 100 and the ancillary device 200 to communicate through a non-line of sight communication link. The mobile terminal 100 may include a display screen 110 and a keypad 105, as shown in FIG. 3A. However, the mobile terminal 100 may include other I/O devices, such as the I/O devices illustrated in FIG. 1. The ancillary device 200 may include a camera 292 and a directional control button 280. However, the ancillary device 200 may include other I/O devices, such as the I/O devices illustrated in FIG. 2.

The mobile terminal 100 and the ancillary device 200 may be sized to be held simultaneously by a user, e.g. one device in each hand.

The mobile terminal 100 may also establish a communication link 312 with a multimedia terminal 305. The communication link 312 may be established using the transceiver 125 and/or using the short range communication interface 115. Accordingly, the multimedia terminal 305 may or may not be located near the mobile terminal 100 and/or the ancillary terminal 200.

Referring to FIG. 3B, the mobile terminal 100 and the ancillary device 200 can communicate with one another via a wired short range communication link 320. In some embodiments, the wired short-range communication link 320 may include a USB and/or Firewire connection, or other wired communication link, that can be made via adapters 315 connected to the mobile terminal 100 and the ancillary device 200.

FIG. 3B also illustrates some possible movements that can be detected by the motion sensor 190 of the mobile terminal 100 and/or by the motion sensor 290 of the ancillary device 200. For example, the mobile terminal 100 and/or the ancillary device 200 may be translated along an x- y- and/or z-axis, and/or may be rotated about the x-, y- or z-axis, and such movements may be detected by the motion sensors 190, 290, therein.

In order to detect motion along an axis, a motion sensor, such as an accelerometer, may be provided in the housing of the mobile terminal and/or the ancillary device and may be aligned along the axis. Accordingly, in order to detect linear motion along the three coordinate axes, three sensors may be used. However, in order to detect rotational motion around an axis, it may be desirable to provide two parallel linear accelerometers in a plane normal to the axis. For example, in order to detect rotation around the z-axis, two parallel accelerometers may be placed in the x-y plane. Thus, in order to detect both rotational and translational movement relative to the x-, y- and z-axes, it may be desirable to provide six accelerometers in the mobile terminal 100 and/or the ancillary device 200 (i.e., two parallel accelerometers per axis).

As noted above, the movements of the mobile terminal 100 may be converted into primary device motion data that may be stored in the memory 130 of the mobile terminal 100. The actuation of a user input device and/or movements of the ancillary device 200 may be converted into ancillary device sensor data that may be stored in the memory 230 of the ancillary device 200 and/or that may be transmitted via a short range communication link 310, 320 to the mobile terminal 100. The ancillary device sensor data may be stored by the mobile terminal 100 in the memory 130. In some embodiments, the ancillary device sensor data may be combined with the primary device motion data, and the combined data may be stored in the memory 130 of the mobile terminal 100.

The primary device motion data and the ancillary device sensor data (or the combined data) may be used by an application program to generate a multimedia object, such as an audio object, an image object and/or a video object. The multimedia object may be generated solely from the motion data and/or may be generated by modifying a preexisting multimedia object based on the motion data. For example, an audio object, such as a music chord, may be modulated in response to the motion data. Likewise, a video object may be generated, manipulated and/or modified in response to the motion data. For example, an attribute of a video object, such as the color, zoom, perspective, skew, etc., of the video object may be modified in response to the motion data.

The multimedia object may then be stored and/or displayed/played, for example at the mobile terminal 100, the ancillary device 200, the multimedia server 305 and/or at another location/device. In some embodiments, the multimedia object may be concurrently generated and played/displayed, for example at the mobile terminal 100, the ancillary device 200, and/or the multimedia server 305. For example, in some embodiments, the multimedia object may be generated and simultaneously played at the mobile terminal 100 to provide immediate feedback to the user. In some embodiments, the multimedia object may be generated at the mobile terminal 100 and transmitted over a communication interface 310, 320 to the ancillary device 200, where it may be concurrently played and/or over a communication interface 312 to the multimedia server 305, where it may be concurrently played.

Some embodiments may permit a user to generate complicated multimedia patterns, such as sound and/or image patterns, based on movements of the mobile terminal 100 and/or the ancillary device 200. In particular, some embodiments may permit a user to generate complicated multimedia objects based on coordinated movements of the mobile terminal 100 and the ancillary device 200.

Some embodiments of the invention may be configured to generate an audio object in response to coordinated movements of the mobile terminal 100 and inputs to the ancillary device 200. For example, the movement of one of the devices may provide a beat, or tempo control, while the movement of the other device and/or a sensor input of the other may provide tone/pitch control. As another example, the movement/sensor input of the devices may correspond to individual percussion instruments, such as drums, cymbals, bells, etc.

Accordingly, as one example, a user may place the mobile device 100 into a multimedia generation mode. The user can then generate a multimedia object, such as an audio object, through coordinated motion of the mobile terminal 100 and/or the ancillary device 200 and/or sensor input from either device. That is, the user may move the mobile terminal 100 and move and/or provide inputs to the ancillary device 200 in a coordinated fashion, and the movement of the mobile terminal 100 and the movement and/or sensor input to the ancillary device 200 may be converted by the respective motion sensors 190, 290 and/or user input devices 255 into motion data. The motion data may be used to generate corresponding audio signals that may be combined to generate an audio object. The audio object may then be stored locally at the mobile device 100 and/or remotely, e.g. at the multimedia server 305, for later access.

In some embodiments, the user may select an existing audio object, such as a song file stored locally at the mobile terminal or remotely at a server, and may play the song using the speaker 135. As the song is playing, the user may add an audio track to the song in response to movements of the mobile terminal 100 and the ancillary device 200. That is, the user may move the mobile terminal 100 and move and/or provide input to the ancillary device 200 in a coordinated fashion, and the movements of the mobile terminal 100 and the movements and/or input to the ancillary device 200 may be converted by the respective sensors 190, 290 and/or input devices 255 into motion data. The motion data may be used to generate corresponding audio signals that may be combined with the existing audio object to generate a modified audio object. The modified audio object may then be stored locally at the mobile device 100 and/or remotely, e.g. at the multimedia server 305, for later access.

Thus, for example, the mobile terminal 100 may be configured to convert the motion data into drum sounds that can be added to a song, whereby the user may add a drum track to the song. Similarly, the mobile terminal 100 may be configured to convert the motion data into guitar sounds that can be added to a song, whereby the user may add a guitar track to the song.

It will be appreciated that according to some embodiments of the invention, the motion data may be converted into sound objects that can be individually stored and combined later. Similarly, the motion data can be used to repetitively modify an audio object to generate a modified audio object.

For example, in a drum generation mode, a user may use the mobile terminal 100 and the ancillary device 200 to generate a drum track in response to movements thereof. The user may then store the drum track and switch to a guitar generation mode. In the guitar generation mode, the user may use the mobile terminal 100 and the ancillary device 200 to generate a guitar track in response to movements thereof, and combine the guitar track with the previously recorded drum track. In this manner, the user may repetitively add tracks to the audio object corresponding to different instruments to eventually build up a complete song.

As noted above, data other than motion data may be sensed by the mobile terminal 100 and/or the ancillary device 200, for example using one or more of the I/O devices described above in connection with FIG. 1 and FIG. 2. Such additional data may be converted into multimedia signals and/or used to generate multimedia signals, that may be combined with the multimedia signals generated in response to the motion data. For example, in addition to moving the ancillary device 200, the user may actuate one or more of the directional buttons 280, which may change the mode of operation, tone, pitch, volume or other property of the audio object being generated.

Multimedia content processing may be performed at the mobile terminal 100 and/or at a remote station, such as the multimedia server 305. Multimedia content processing may be performed according to Java Multimedia API defined in Java Multimedia standard JSR-000135 and/or Java Multimedia standard JSR-000234, which define standard interfaces for playing and recording multimedia objects, such as audio objects, video objects and still images for Java-compliant devices.

Motion events may be retrieved from the sensors of the mobile terminal 100 and/or the sensors of the ancillary device 200 using, for example, Java Multimedia standard JSR-000256, which defines standard interfaces for transmitting and receiving sensor information for Java-compliant devices.

The present invention is described hereinafter with reference to flowchart and/or block diagram illustrations of methods, mobile terminals, electronic devices, data processing systems, and/or computer program products in accordance with some embodiments of the invention. These flowchart and/or block diagrams further illustrate methods of operating mobile devices in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks. These computer program instructions may also be stored in a computer usable or computer-readable memory that may direct a computer or other programmable data processing apparatus to function/act in a particular manner, such that the instructions stored in the computer usable or computer-readable memory produce an article of manufacture including instructions that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

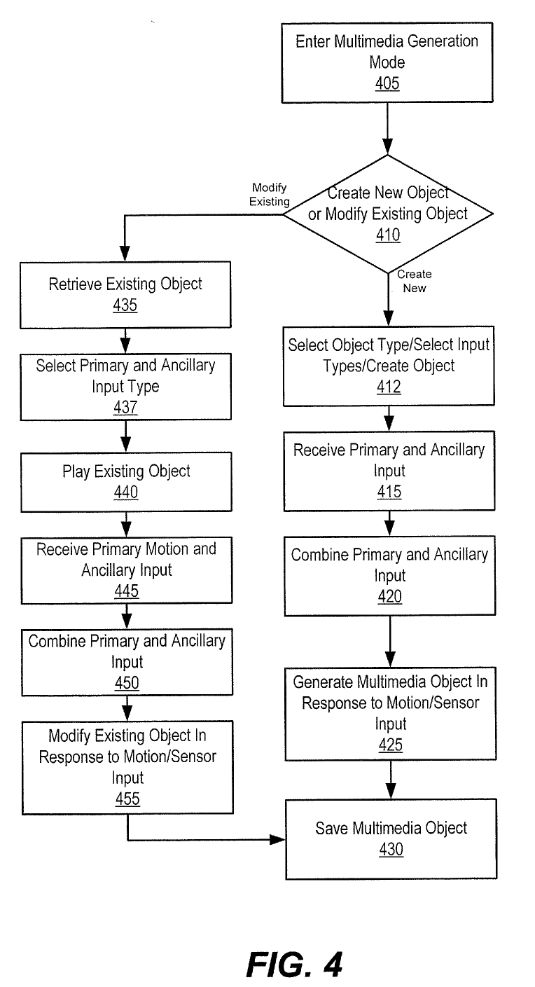

FIG. 4 is a flowchart illustrating exemplary methods for operating mobile devices in accordance with some embodiments of the present invention. Referring now to FIG. 4, operations begin at block 405 when the mobile terminal 100 is placed into a multimedia content generation mode. In the multimedia content generation mode, the mobile terminal 100 may be configured to not respond to incoming call alerts from a network, such as a cellular communication network with which the mobile terminal is registered. Similarly, in the multimedia content generation mode, the mobile terminal 100 may be configured to send a “busy” status signal to the network in response to an incoming call notification, so that incoming calls may not interrupt the generation of multimedia content. In other embodiments, the mobile terminal 100 may be configured to forward an incoming call to a call forwarding number and/or a voicemail mailbox. In some embodiments, the mobile terminal 100 may be configured to automatically switch to a silent ring, and/or to provide a vibrating signal and/or a flashing light signal upon receipt of an incoming call while in the multimedia content generation mode.

Once the mobile terminal 100 has been placed in the multimedia content generation mode, the user may choose to create a new multimedia file or modify an existing multimedia object (block 410) by, for example, selecting an appropriate option on a menu screen. If the user chooses to create a new multimedia object, then the user may be prompted to select an object type (e.g. sound object, picture object, video object, etc.) (block 412). The user may also select the type of input that will be made through the primary and ancillary devices 100, 200. For example, the user may select to use the primary device 100 as a drum and the ancillary device 200 as a cymbal. Next, the primary device 100 and the ancillary device 200 begin to generate primary and ancillary input signals in response to movement of the devices and/or actuation of input devices by the user (block 415). The ancillary input signals are transmitted by the ancillary device 200 to the primary device 100.

The primary and ancillary inputs may optionally be combined (block 420). In some embodiments, the primary and ancillary inputs may be combined at the primary device 100 to form a combined input. In other embodiments, the primary and ancillary input signals may be forwarded by the primary device 100 via a communication link 312 with a multimedia terminal 305 (FIG. 3), and the primary and ancillary motion input signals may be combined and/or interpreted at the multimedia terminal 305.

A multimedia object is then generated in response to the primary and secondary input signals, or in response to a combined input signal (block 425). The multimedia object is then saved (block 430). The multimedia object can be saved and played, for example, at the primary device 100 and/or at the multimedia terminal 305.

If at block 410 the user chooses to modify an existing object, then the existing object is retrieved from storage (block 435). The multimedia object can be stored, for example, in a volatile and/or nonvolatile memory 230 of the primary device, and/or in a volatile and/or nonvolatile memory of the multimedia server.

The user may then choose a primary and ancillary input type, as discussed above (block 437). The existing object is then played at the primary device 100 using, for example, the display 210 and/or the speaker 235 of the primary device 100.

Next, the primary device 100 and the ancillary device 200 begin to generate primary and ancillary input signals in response to movement of the devices and/or actuation of input devices thereon by the user (block 445). The ancillary input signals are transmitted by the ancillary device 200 to the primary device 100.

The primary and ancillary input signals may optionally be combined (block 450). For example, the primary and ancillary input signals may be combined at the primary device 100 to form a combined input signal, or the primary and ancillary input signals may be forwarded by the primary device 100 via a communication link 312 with a multimedia terminal 305 (FIG. 3), and the primary and ancillary input signals may be combined and/or interpreted at the multimedia terminal 305.

The existing multimedia object is then modified in response to the primary and secondary input signals, or in response to a combined input signal (block 455). Finally, the modified multimedia object is saved (block 430).

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method of operating a mobile device, comprising:
detecting a motion of the mobile device having a transceiver configured to communicate with a wireless communication network, using a sensor associated with the mobile device, and generating a signal indicative of the motion of the mobile device;
receiving an ancillary sensor signal from a sensor of an ancillary device associated with the mobile device;
generating a multimedia object in response to the motion of the mobile device and/or the ancillary sensor signal; and
storing the multimedia object.

2. The method of claim 1, further comprising combining the signal indicative of the motion of the mobile device with the ancillary sensor signal to form a combined input signal wherein generating the multimedia object is performed in response to the combined input signal.

3. The method of claim 2, further comprising transmitting the signal indicative of the motion of the mobile device and the ancillary sensor signal to a remote terminal, wherein combining the signal indicative of the motion of the mobile device with the ancillary sensor signal to form a combined input signal is performed at the remote terminal.

4. The method of claim 1, wherein the ancillary sensor signal comprises a signal indicative of a motion of the ancillary device.

5. The method of claim 1, wherein generating the multimedia object comprises generating the multimedia object in response to the motion of the mobile device, the ancillary sensor signal, and a signal indicative of a motion of the ancillary device.

6. The method of claim 1, wherein the multimedia object comprises a sound file, an image file, and/or a video file, the method further comprising playing the multimedia object using the mobile device and/or the ancillary device.

7. The method of claim 1, further comprising transmitting the multimedia object to a remote terminal, and storing the multimedia object at the remote terminal.

8. The method of claim 1, further comprising transmitting the ancillary sensor signal to the mobile device using a short-range wireless communication interface comprising an RF or infrared communication interface.

9. The method of claim 1, further comprising placing the mobile device into a multimedia content generation mode prior to detecting the motion of the mobile device.

10. The method of claim 9, wherein in the multimedia content generation mode, the mobile device is configured to not respond to incoming call alerts from the wireless communication network, to send a “busy” status signal to the network in response to an incoming call notification, and/or to forward an incoming call received over the wireless communication network to a call forwarding number and/or a voicemail mailbox.

11. The method of claim 1, further comprising:
selecting an object type for the multimedia object; and
selecting an input type for the mobile device and the ancillary device.

12. A method of operating a mobile device, comprising:
retrieving an existing multimedia object;
detecting a motion of the mobile device having a transceiver configured to communicate with a wireless communication network, using a sensor associated with the mobile device, and generating a signal indicative of the motion of the mobile device;
receiving an ancillary sensor signal in response to an input of an ancillary device associated with the mobile device;
modifying the existing multimedia object in response to the motion of the mobile device and/or the ancillary sensor signal to generate a modified multimedia object; and
storing the modified multimedia object.

13. The method of claim 12, further comprising combining the signal indicative of the motion of the mobile device with the ancillary sensor signal to form a combined input signal, wherein modifying the multimedia object is performed in response to the combined input signal.

14. The method of claim 12, wherein the ancillary sensor signal comprises a signal indicative of a motion of the ancillary device.

15. A mobile device, comprising:
a sensor configured to detect a motion of the mobile device and generate a signal indicative of a motion of the mobile device;
a transceiver configured to communicate with a wireless communication network;
a short-range wireless communication interface configured to receive an ancillary sensor signal from an ancillary device; and
a controller configured to generate a multimedia object in response to the signal indicative of the motion of the mobile device and/or the ancillary sensor signal, and to store the multimedia object.

16. The device of claim 15, wherein the controller is further configured to combine the signal indicative of the motion of the mobile device with the ancillary sensor signal to form a combined input signal and to generate the multimedia object in response to the combined input signal.

17. The device of claim 15, wherein the controller is configured to place the mobile device into a multimedia content generation mode in which the mobile device is configured to not respond to incoming call alerts from the wireless communication network, to send a “busy” status signal to the network in response to an incoming call notification, and/or to forward an incoming call received over the wireless communication network to a call forwarding number and/or a voicemail mailbox.

18. The device of claim 15, wherein the controller is configured to generate the multimedia object in response to the signal indicative of the motion of the mobile device, the ancillary sensor signal, and a signal indicative of a motion of the ancillary device.

19. The device of claim 15, wherein the controller is configured to retrieve an existing multimedia object and to modify the existing multimedia object in response to the signal indicative of the motion of the mobile device and the ancillary sensor signal.

20. The device of claim 15, wherein the sensor comprises a motion sensor including a pair of parallel sensors configured to sense linear motion along a first axis and rotational motion along a second axis that is orthogonal to the first axis, and wherein the motion sensor is configured to generate the signal indicative of a motion of the mobile device.
